(19) United States
(12) Patent Application Publication
(10) Pub. No.: US 2022/0071449 A1
(43) Pub. Date: Mar. 10, 2022

(54) AGITATOR

(71) Applicant: BREVILLE PTY LIMITED, Alexandria (AU)

(72) Inventors: Eddie SIU, Alexandria (AU); Khon THAI, Alexandria (AU); Bin GENG, Alexandria (AU)

(21) Appl. No.: 17/416,503

(22) PCT Filed: Dec. 17, 2019
(86) PCT No.: PCT/AU2019/051387

§ 371 Date: Jun. 20, 2021

(30) Foreign Application Priority Data
Dec. 21, 2018 (AU) 2018904902

(51) Int. Cl. A47J 43/07; A47J 43/046; A47J 36/16; B01F 7/00; B01F 7/16

(52) U.S. Cl. CPC A47J 43/0722; A47J 43/046; A47J 36/165; B01F 7/00208; B01F 2215/0026; B01F 7/162; B01F 7/00033; B01F 7/0005; B01F 7/00583

(57) ABSTRACT

An agitator (10) for a kitchen device (68), the kitchen device (68) having: a vessel (56) with a bottom wall (62) and an upwardly extending side wall (70), the bottom wall (62) and the side wall (70) providing a space (72) to receive ingredients to be processed, the side wall (70) extending upwardly to a rim (74) that at least partly surrounds a top opening (76) to the space (72); a blade assembly (54) located in the space (72) to process the ingredients and to be rotatably driven in a rotation direction (22) about a generally upright axis (20); and a drive assembly to rotatably drive the blade assembly (54) about the axis (20); the agitator (10) including: a hub (12) to be coupled to the blade assembly (54) so as to be rotated thereby about the axis (20); a plurality of arms (14) fixed to the hub (12) and extending outwardly therefrom so as to have a major direction of extension that is generally radial relative to the axis (20); and wherein at least one of the arms (14) projects below said hub (12) so as to provide a scraping member (48) adjacent the bottom wall (62) to move ingredients relative to the bottom wall (62).

### FIELD

This invention relates to an agitator for a kitchen device.

### BACKGROUND

Kitchen devices having heating elements to heat a vessel of the kitchen device have become increasingly popular. The presence of a heating element can lead to portions of ingredients being processed by the kitchen device to adhere to a bottom surface of the vessel. This problem becomes more pronounced as the power of the heating element is increased. Further, the ingredients adhering to the bottom surface of the vessel can form an insulating layer which decreases the accuracy of a temperature sensor located near the bottom surface. In some cooking applications it is paramount to sense the temperature of the ingredients as accurately as possible, for example when preparing custard.

The decreased accuracy also results in delays in thermal response by the heating element to changes in ingredient temperature, exacerbating the adhesion of ingredients.

Currently used agitators attempt to solve these problems by increasing agitation of ingredients, which agitates the ingredients undesirably frequently and violently.

### SUMMARY OF INVENTION

It is an object of the invention to address one or more of the above discussed problems, or at least provide a suitable alternative to the above discussed agitators.

In a first aspect the present invention provides an agitator for a kitchen device, the kitchen device having:

a vessel with a bottom wall and an upwardly extending side wall, the bottom wall and the side wall providing a space to receive ingredients to be processed, the side wall extending upwardly to a rim that at least partly surrounds a top opening to the space;

a blade assembly located in the space to process the ingredients and to be rotatably driven in a rotation direction about a generally upright axis; and

a drive assembly to rotatably drive the blade assembly about the axis; the agitator including:

a hub to be coupled to the blade assembly so as to be rotated thereby about the axis;

a plurality of arms fixed to the hub and extending outwardly therefrom so as to have a major direction of extension that is generally radial relative to the axis; and

wherein at least one of the arms projects below said hub so as to provide a scraping member adjacent the bottom wall to move ingredients relative to the bottom wall.

Preferably, the kitchen device includes a lid fixed to the rim, and wherein the agitator is configured to extend between the blade assembly and lid so as to be supported for rotation about the axis.

Preferably, the agitator further includes a column extending upwardly from the hub, the column having a bearing surface configured to rotatably engage a compatible bearing surface in the lid so as to support the agitator for rotation about the axis.

Preferably, the column further has a compressible member bearing against a flange located on the column, the compressible member being configured to urge the column downwards when the bearing surfaces are rotatably engaged.

Preferably, the at least one arm includes a body fixed to the hub, with said scraping member attached to a lower portion of the body.

Preferably, the scraping member is removably attached to the body.

Preferably, the body has an elongated recess for holding the scraping member, the recess extending substantially radially to the axis.

Preferably, the recess has:
an opening for receiving the scraping member; and
a stopper for retaining the scraping member.

Preferably, the opening is located at a proximal end of the body adjacent the hub, and the stopper is located at a distal end of the body.

Preferably, the scraping member has a retaining body, the retaining body having a cross-section substantially complementary to a cross-section of the recess such that the retaining body is retained by the recess, thereby retaining the scraping member.

Preferably, the scraping member includes a scraping lip to extend toward the bottom wall, the scraping lip having a major direction of extension generally radially relative to the axis and extending downwardly from the body.

Preferably, the at least one arm is of a unitary construction.

Preferably, the scraping member is formed from a different material than the arms and co-moulded or insert moulded.

Preferably, the scraping member is elastically deformable against the bottom wall.

Preferably, each arm has:

a leading edge extending in the rotation direction and downwardly from the body; and a trailing edge extending opposite the rotation direction and downwardly from the body.

Preferably, a lowest extent of the scraping member is below a lowest extent of the leading edge and/or the trailing edge.

Preferably, the scraping member is a scourer.

Preferably, the agitator further includes a plurality of whisk members extending upwardly from each arm.

Preferably, the agitator further includes at least one secondary whisk member intersecting the plurality of whisk members.

Preferably, at least a portion of the whisk members is formed of metal wire.

Preferably, at least a portion of the whisk members is formed of plastic.

In a second aspect the present invention provides a kitchen device having an agitator according to the first aspect.

### BRIEF DESCRIPTION OF DRAWINGS

Preferred embodiments of the present invention will now be described, by way of examples only, with reference to the accompanying drawings:

FIG. 1 is a perspective view of an agitator according to an embodiment of the invention.

FIG. 2 is a cut-away perspective view of the agitator of FIG. 1 positioned in a vessel of a kitchen device.

FIG. 3 is a perspective view of the agitator of FIG. 1.

FIG. 4 is a perspective view of the agitator of FIG. 1.

FIG. 5 is a detailed side section view of the agitator of FIG. 1 being positioned in the vessel.

FIG. 6 is a detailed side section view of the agitator of FIG. 1 positioned in the vessel.

FIG. 7 is a side section view of the agitator of FIG. 1 positioned in the vessel.

FIG. 8 is a side section view of an agitator according to a second embodiment of the invention.

### DESCRIPTION OF EMBODIMENTS

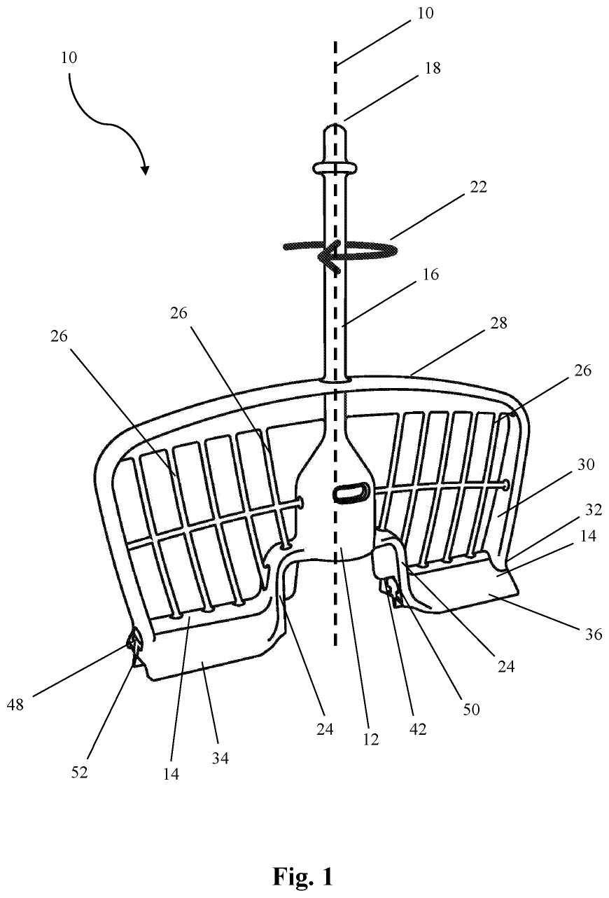

As shown in FIG. 1, an agitator 10 for a kitchen device 68 includes a hub 12 and two arms 14 extending outwardly from the hub 12. The hub 12 has a column 16 extending upwardly from the hub 12. The column 16 has a bearing surface 18. The column 16 extends along an axis 20, about which the agitator 10 may be moved in a rotation direction 22.

The arms 14 are substantially perpendicular to the axis 18 and are joined to the hub 12 by a drive section 24 that extends downwardly proximal to the hub 12. The arms 14 further each have a body 15 extending substantially perpendicular to the axis 18. The agitator 10 further has a plurality of whisk members 26 extending upwardly from the arms 14. The whisk members 26 are also joined and connected to the hub 12, at an end opposite the arms 14, by a cross member 28. The arms 14 are each connected to the cross member 24 by an end column 30 at a distal end 32 of the arms 14. In this embodiment, the whisk members 26 are formed of plastic. In another embodiment, the whisk members 26 may be formed of metal wire. In yet another embodiment, some of the whisk members 26 may be formed of metal wire while other whisk members 26 may be formed from plastic.

Each body 15 has a leading edge 34 and a trailing edge 36. Each leading edge 34 extends from the body 15 in the rotation direction 22 and downwardly. Each trailing edge 36 extends from the body 15 opposite the rotation direction 22 and downwardly. The leading edge 34 and trailing edge 36 slope upwardly and meet at an apex 38.

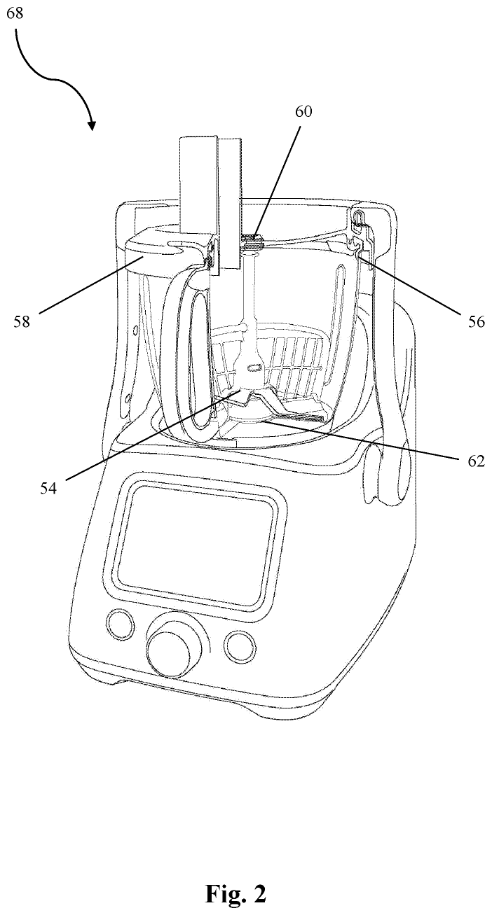

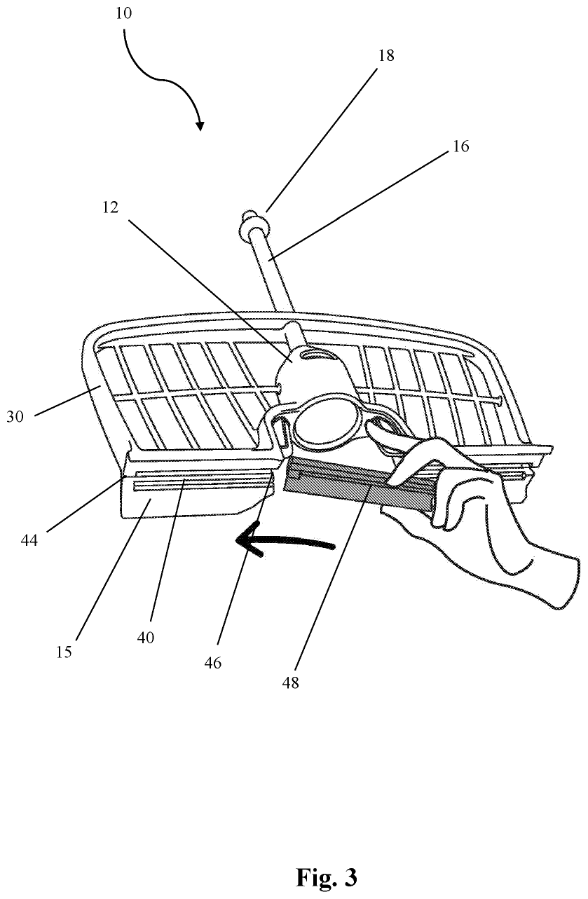

As shown in FIG. 2, each body 15 has a recess 40 located between the leading edge 34 and the trailing edge 36. The recess 40 extends between a proximal end 42 adjacent the hub 12, and a distal end 32 of the body 15. At the distal end 32, the recess 40 is terminated by a stopper 44, at the proximal end 42 the recess 40 has an opening 46. A scraping member 48 is received in the recess 40, as shown in FIG. 3 and extends downwardly from the body 15 such that a lowest extent of the scraping member 48 is below a lowest extent of leading edge 34 and/or the trailing edge 36. Alternatively, the scraping member 48 could be provided by a projection of the arm 14 below the hub 12. In another contemplated alternative, only one body 15 is provided with a scraping member 48.

The scraping member 48 is formed of a soft elastomer, preferably a more compliant material than the leading and trailing edge 34, 36. In another embodiment, the scraping member 48 may be a scourer. The scraping member 48 may be a separate, replaceable part, as shown in this embodiment, or co-moulded, or insert moulded with the agitator 10. The scraping member 48 has a retaining body 50 and a scraping lip 52 extending downwardly from the retaining body 50. The lowest extent of the scraping lip 52 is below the lowest extend of the leading edge 34 and the trailing edge 36. The retaining body 50 has a cross-section with a complimentary profile to a cross-section of the recess 40.

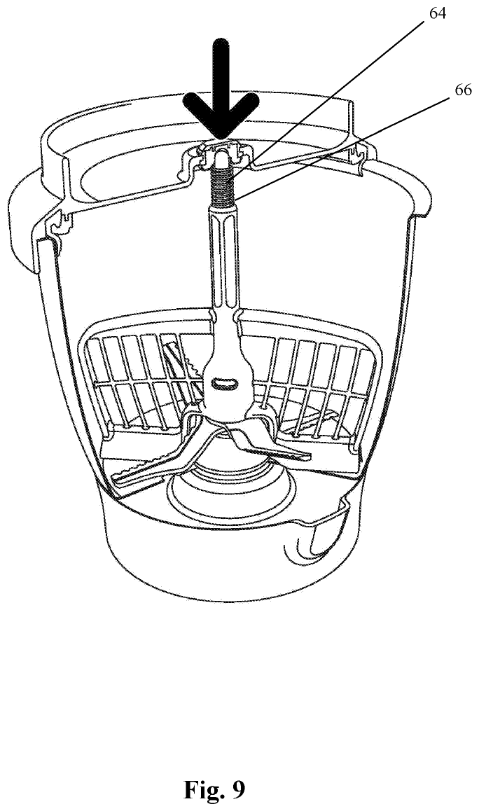

Referring now to FIG. 8, which shows a second embodiment of the agitator 10. In this embodiment, the agitator 10 includes a compressive member, preferably a spring 64. In this embodiment, the column 16 has a flange 66. The spring 64 is located above the flange 66 such that a lower end of the spring 64 abuts the flange 66.

Use of the agitator 10 will now be discussed.

For a first use of the agitator 10, or when required, the scraping member 48 is inserted into the recess 40, as shown in FIGS. 2 and 3, by guiding the scraping member 48 into the opening 46 until the scraping member 48 abuts the stopper 44.

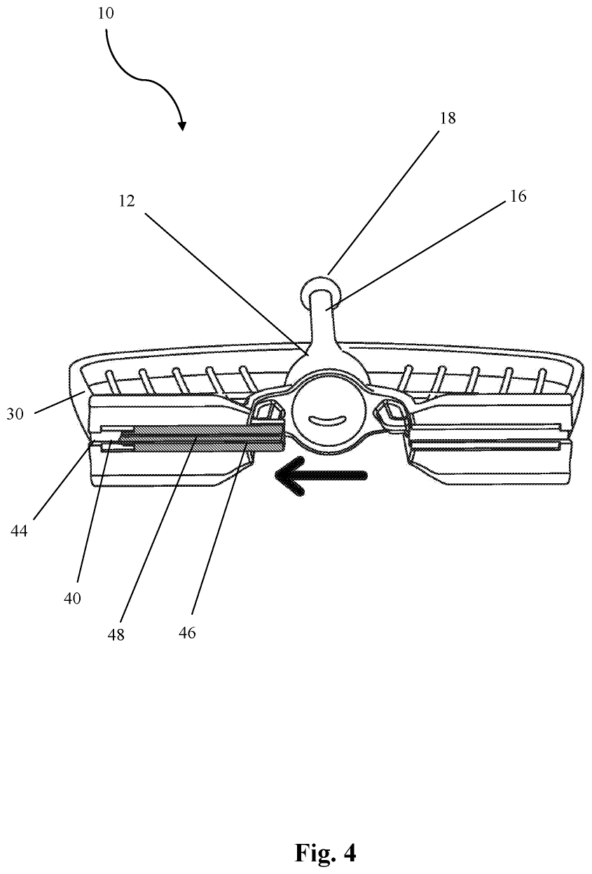

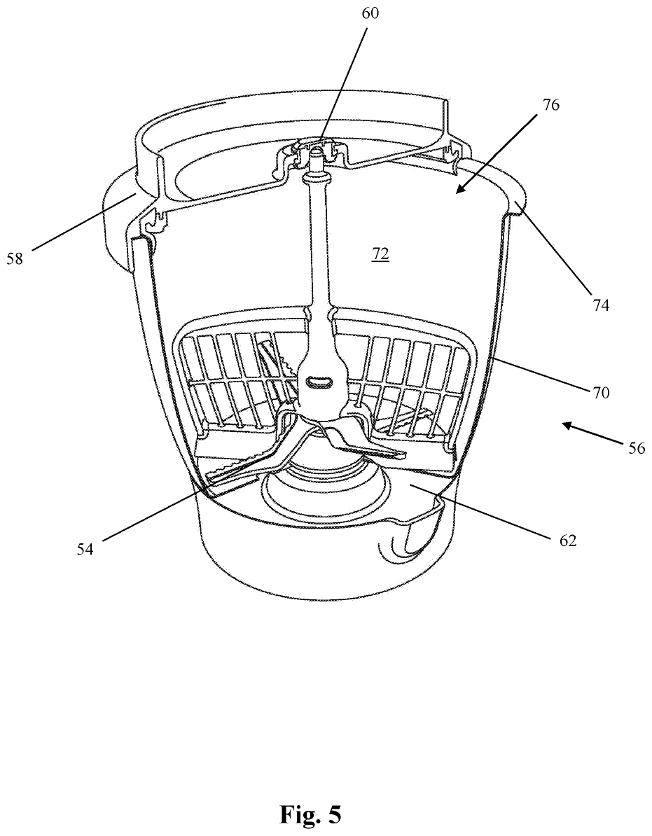

As shown in FIG. 4, the agitator 10 is then placed atop a blade assembly 54 inside a vessel 56. As shown in FIG. 5, the vessel 56 has a bottom wall 62 and an upwardly extending side wall 70, the bottom wall 62 and the side wall 70 providing a space 72 to receive ingredients to be processed, the side wall 70 extending upwardly to a rim 74 that at least partly surrounds a top opening 76 to the space 72. A lid 58 is placed atop the vessel 56 to close the vessel 56. The lid 58 has a bearing surface 60.

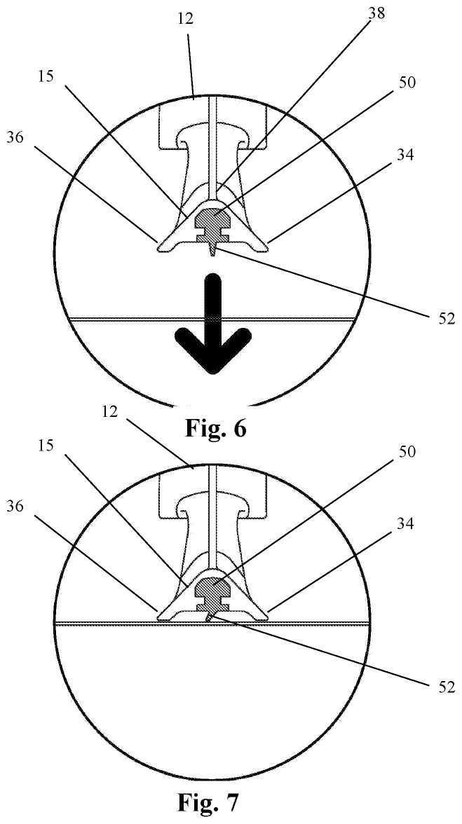

As shown in FIGS. 5 and 6, as the agitator 10 is placed atop the blade set 54, the scraping lip 52 is urged against a bottom wall 62 of the vessel 56. The scraping lip 52 elastically deforms against the bottom wall 62 under the weight of the agitator 10 such that the scraping lip 52 maintains sufficient contact with the bottom wall 62 to remove ingredients from the bottom wall 62.

Returning to FIG. 4, as the lid 58 is placed atop the vessel 56, the bearing surface 60 of the lid 58 rotatably engages the bearing surface 18 of the column 16. As the lid 58 is secured against the vessel 56, the lid 58 urges the column 16, and thereby the agitator 10, downwards and against the bottom wall 62, further improving contact between the scraping lip 48 and the bottom wall 62.

The drive section 24 of the arms 14 engages the blade assembly 54, such that movement of the blade assembly 54 moves the agitator 10 in the rotation direction 22 about the axis 20. As the agitator 10 is moved about the axis 20, the scraping lip 52 moves ingredients relative to the bottom wall 62. The blade assembly 54 is driven about the axis 20 by a drive assembly (not shown), for example an electric motor.

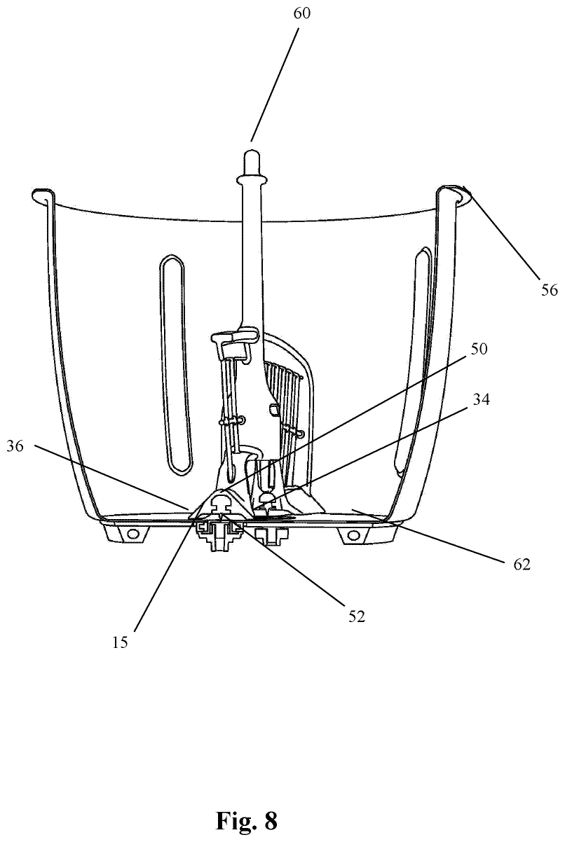

Referring to FIG. 7, showing the second embodiment of the agitator 10, wherein, the spring 64 is located between the flange 66 and the lid 58 to urge the column 16, and thereby the agitator 10, downwards to improve contact between the scraping lip 52 and the bottom wall 62. In this embodiment the bearing surfaces 18, 60 remain rotatably engaged.

Advantages of the agitator 10 will now be discussed.

Because the lowest extent of the scraping member 48 contacts the bottom wall 62 of the vessel 56, the scraping lip 52 is able to remove ingredients that have adhered to the bottom surface 62 of the vessel 56. The engagement of the bearing surfaces 18, 60 improves the contact of the scraping lip 52 with the bottom surface 62, enabling more ingredients to be removed by the scraping lip 52.

The spring 64 similarly improves the contact of the scraping lip 52 with the bottom wall 62. However, the spring 64 also allows the column 16 to be urged downwardly across a larger distance, such that a variation in the distance between the bearing surfaces 18, 60, for example due to manufacturing tolerances, can be tolerated.

The soft elastically, or resiliently, deformable material of the scraping lip 52, which is preferably different to the material of the agitator 10, also allows the scraping lip 52 to be compressed against the bottom wall 62, and for the distance at which this compression occurs to be variable, due to, for example, manufacturing tolerances. As the scraping lip 52 is subjected to wear during use, the scraping member 48 remains usable as the scraping lip 52 remains in contact with the bottom wall 62, albeit less deformed.

Because the scraping member 48 is replaceable, it is possible to replace the part of the agitator 10 that is most exposed to destructive friction, without having to replace the entire agitator 10.

The recesses 40 have stoppers 44 located at their distal ends 32 such that, when the agitator 10 is moved about the axis 20, the scraping members 48 are prevented from being dislodged from the recesses 40 due to a centrifugal force caused by the movement.

The leading and trailing edges 34, 36 provide a gentle surface to displace ingredients that are not adhered to the bottom wall 62, avoiding undesirable damage to the ingredients, or splashing in the vessel 56. The leading and trailing edges 34, 36 do not extend to the bottom wall 62, such that they are not exposed to the destruction friction experienced by the scraping member 48.

The whisk members 26 are provided to thoroughly mix large quantities of ingredients in the vessel 56. If formed from a metal wire, they provide good durability, while if they are formed from plastic, they avoid unnecessary damage to ingredients.

Preferably, the arms 14, and more preferably the agitator 10, is formed as a unitary part, which greatly reduces manufacturing costs and increases durability.

1. An agitator for a kitchen device, the kitchen device having:
a vessel with a bottom wall and an upwardly extending side wall, the bottom wall and the side wall providing a space to receive ingredients to be processed, the side wall extending upwardly to a rim that at least partly surrounds a top opening to the space;
a blade assembly located in the space to process the ingredients and to be rotatably driven in a rotation direction about a generally upright axis; and
a drive assembly to rotatably drive the blade assembly about the axis; the agitator including:
a hub to be coupled to the blade assembly so as to be rotated thereby about the axis;
a plurality of arms fixed to the hub and extending outwardly therefrom so as to have a major direction of extension that is generally radial relative to the axis; and
wherein at least one of the arms projects below said hub so as to provide a scraping member adjacent the bottom wall to move ingredients relative to the bottom wall.

2. The agitator of claim 1, wherein the kitchen device includes a lid fixed to the rim, and wherein the agitator is configured to extend between the blade assembly and lid so as to be supported for rotation about the axis.

3. The agitator of claim 2, wherein the agitator further includes a column extending upwardly from the hub, the column having a bearing surface configured to rotatably engage a compatible bearing surface in the lid so as to support the agitator for rotation about the axis.

4. The agitator of claim 3, wherein the column further has a compressible member bearing against a flange located on the column, the compressible member being configured to urge the column downwards when the bearing surfaces are rotatably engaged.

5. The agitator of claim 1, wherein the at least one arm includes a body fixed to the hub, with said scraping member attached to a lower portion of the body.

6. The agitator of claim 5, wherein the scraping member is removably attached to the body.

7. The agitator of claim 6, wherein the body has an elongated recess for holding the scraping member, the recess extending substantially radially to the axis.

8. The agitator of claim 7, wherein the recess has:
an opening for receiving the scraping member; and
a stopper for retaining the scraping member.

9. The agitator of claim 8, wherein the opening is located at a proximal end of the body adjacent the hub, and the stopper is located at a distal end of the body.

10. The agitator of any one of claims claims 7 to 9, wherein the scraping member has a retaining body, the retaining body having a cross-section substantially complementary to a cross-section of the recess such that the retaining body is retained by the recess, thereby retaining the scraping member.

11. The agitator of any one of claims 5 to 10, wherein the scraping member includes a scraping lip to extend toward the bottom wall, the scraping lip having a major direction of extension generally radially relative to the axis and extending downwardly from the body.

12. The agitator of any one of claims 5 to 11, wherein each arm has:
a leading edge extending in the rotation direction and downwardly from the body; and
a trailing edge extending opposite the rotation direction and downwardly from the body.

13. The agitator of claim 12, wherein a lowest extent of the scraping member is below a lowest extent of the leading edge and/or the trailing edge.

14. The agitator of any one of claims 1 to 13, wherein the at least one arm is of a unitary construction.

15. The agitator of claim 14, wherein the scraping member is formed from a different material than the arms and is co-moulded or insert moulded.

16. The agitator of any one of claims 1 to 15, wherein the scraping member is elastically deformable against the bottom wall.

17. The agitator of any one of claims 1 to 16, wherein the scraping member is a scourer.

18. The agitator of any one of claims 1 to 17, wherein the agitator further includes a plurality of whisk members extending upwardly from each arm.

19. The agitator of claim 18, wherein the agitator further includes at least one secondary whisk member intersecting the plurality of whisk members.

20. The agitator of claim 18 or 19, wherein at least a portion of the whisk members is formed of metal wire.

21. The agitator of any one of claims 18 to 20, wherein at least a portion of the whisk members is formed of plastic.

22. A kitchen device having the agitator of any one of claims 1 to 21.
